(19) United States
(12) Patent Application Publication
(10) Pub. No.: US 2015/0181530 A1
(43) Pub. Date: Jun. 25, 2015

(54) METHOD AND ELECTRONIC DEVICE FOR SEARCHING FOR NETWORK IN WIRELESS COMMUNICATION ENVIRONMENT SUPPORTING A PLURALITY OF COMMUNICATION METHODS

(71) Applicant: Samsung Electronics Co., Ltd., Gyeonggi-do (KR)

(72) Inventors: Chung-Ik LEE, Gyeonggi-do (KR); Hun-Cheol OH, Seoul (KR)

(73) Assignee: Samsung Electronics Co., Ltd.

(21) Appl. No.: 14/581,282

(22) Filed: Dec. 23, 2014

(30) Foreign Application Priority Data
Dec. 23, 2013 (KR) 10-2013-0161636

(51) Int. Cl. H04W 52/02; H04W 48/16

(52) U.S. Cl. CPC H04W 52/0261; H04W 48/16

(57) ABSTRACT

A method and device for searching for a network in a wireless communication environment that supports a plurality of communication methods are provided. The method of searching for a network performed by an electronic device includes determining a battery level of the electronic device; searching for a first frequency band, when it is determined that the battery level is greater than or equal to a threshold value; and searching for a second frequency band, when it is determined that the battery level is less than the threshold value. The first frequency band includes an entire frequency band corresponding to a network which the electronic device supports, and the second frequency band includes a frequency band other than at least one frequency band included in the first frequency band.

### PRIORITY

This application claims priority under 35 U.S.C. §119(a) to a Korean Patent Application filed in the Korean Intellectual Property Office on Dec. 23, 2013 and assigned Serial No. 10-2013-0161636, the entire content of which is incorporated herein by reference.

### BACKGROUND

1. Field of the Invention

The present invention generally relates to an electronic device, and more particularly, to a method and device for searching for a network in a wireless communication environment that supports a plurality of communication methods.

2. Description of the Related Art

As an electronic device provides a multimedia service, the amount of information to process or to display increases. Such an electronic device uses a battery as a power supply means and a battery of a larger capacity is needed. However, due to the slow development of a large capacity battery, the capacity of present the battery is limited.

In order to reduce consumption of the battery, the electronic device may enter a low power mode. In the low power mode, an operation of applying low power to a module in the electronic device may be performed. For example, when a user input is not detected for a predetermined time period, the electronic device may apply low power to a backlight device and a short range communication module.

An electronic device using a battery as a power supply means may limit a use time according to a battery capacity and increase a use time by reducing power consumption.

For example, the electronic device performs an operation of searching for an entire frequency band of a communication method which the electronic device supports. However, even when operating in a low power mode, the electronic device may perform an operation of searching for an entire frequency band, and the frequency band search operation is performed regardless of a battery level, even when it is determined that a battery level is less than a threshold value.

When the electronic device can perform communication with a plurality of networks, a frequency band of a network that the electronic device should search for increases, and the electronic device searches for a full frequency band. Thus, a network search time may be extended and excessive power consumption may occur.

### SUMMARY

The present invention has been made to solve at least the above-mentioned problems and/or disadvantages and to provide at least the advantages described below.

Accordingly, an aspect of the present invention is to provide an electronic device that may control a network search operation according to a previously defined condition. For example, the previously defined condition may be related to a state of the electronic device, such as at least one of a battery level and a location of the electronic device and an available service in the electronic device.

Another aspect of the present invention is to provide an electronic device that may not perform a search operation for at least one frequency band, except for a main frequency of an entire frequency band which the electronic device supports according to a previously defined condition.

Another aspect of the present invention is to provide an electronic device that may preferentially search for a main frequency band of an entire frequency band which the electronic device supports according to a previously defined condition or may reduce a search for the other frequency bands other than a main frequency band. The main frequency band may include a network generally used in the electronic device before a previously defined condition is satisfied, for example, before it is determined that a battery level is less than a threshold value and a frequency band of a network that may be used at a present location by a present setting of the electronic device.

In accordance with an aspect of the present invention, a method of searching for a network performed by an electronic device is provided. The method includes determining a battery level of the electronic device; searching for a first frequency band, when it is determined that the battery level is greater than or equal to a threshold value; and searching for a second frequency band, when it is determined that the battery level is less than the threshold value. The first frequency band includes an entire frequency band corresponding to a network which the electronic device supports, and the second frequency band includes a frequency band other than at least one frequency band included in the first frequency band.

In accordance with another aspect of the present invention, an electronic device for searching for a network is provided. The electronic device includes a first modem that searches for a frequency band corresponding to a first communication method; a second modem that searches for a frequency band corresponding to a second communication method; and a controller that determines situation information of the electronic device, that searches for a frequency band using the first modem and the second modem, when it is determined that the situation information does not satisfy a condition, and that searches for a frequency band using the first modem or the second modem, when it is determined that the situation information satisfies the condition.

In accordance with another aspect of the present invention, a non-transitory computer readable recording medium is provided. The computer-readable recording medium is encoded with a program for causing an electronic device to perform an operation of searching for a full frequency band using a first modem and a second modem and an operation of controlling the first modem or the second modem based on a battery level of the electronic device that is recorded in the electronic device.

### BRIEF DESCRIPTION OF THE DRAWINGS

The above and other aspects, features and advantages of certain embodiments of the present invention will be more apparent from the following detailed description, taken in conjunction with the accompanying drawings, in which:

FIG. 1 illustrates an electronic device according to an embodiment of the present invention;

FIG. 2 is a block diagram illustrating a configuration of an electronic device according to an embodiment of the present invention;

FIG. 3A is a diagram illustrating a network search operation of an electronic device according to an embodiment of the present invention;

FIG. 3B is a diagram illustrating a network search operation of an electronic device according to an embodiment of the present invention;

FIG. 4 is a block diagram illustrating a configuration of an electronic device according to an embodiment of the present invention;

FIG. 5 is a flowchart illustrating a network search operation of an electronic device according to an embodiment of the present invention; and

FIG. 6 is a flowchart illustrating a network search operation of an electronic device according to another embodiment of the present invention.

### DETAILED DESCRIPTION OF EMBODIMENTS OF THE PRESENT INVENTION

Hereinafter, various embodiments of the present invention will be described in detail with reference to the accompanying drawings. Detailed descriptions of well-known functions and structures incorporated herein may be omitted to avoid obscuring the subject matter of the present invention. The terms used herein are defined according to the functions of the present invention and may vary depending on a user's or an operator's intention and usage. Therefore, the terms used herein should be understood based on the descriptions made herein.

In the following description, an electronic device may include at least one of a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), a Moving Picture Experts Group layer-3 (MP3) player, a mobile medical device, a camera, a wearable device, an electronic clock, a wrist watch, a refrigerator, an air-conditioner, a vacuum cleaner, an artificial intelligence robot, a television, a Digital Video Disk (DVD) player, an audio device, an oven, a microwave oven, a washing machine, an air cleaner, a medical device (e.g., a Magnetic Resonance Angiography (MRA) device, a Magnetic Resonance Imaging (MRI) device, a Computed Tomography (CT) device, a scanning machine, and an ultrasonic wave device), a navigation device, a Global Positioning System (GPS) receiver, an Event Data Recorder (EDR), a Flight Data recorder (FDR), a set-top box, a television box (e.g., Samsung HomeSync™, Apple TV™, or Google TV™), an electronic dictionary, a vehicle infotainment device, an electronic equipment for ship (e.g., a navigation device for ship and gyro compass), avionics, a security device, a camcorder, game consoles, a portion of furniture or a building/structure including an electronic device, an electronic board, an electronic signature receiving device, and a projector. However, an electronic device according to an embodiment of the present invention is not limited to the foregoing devices.

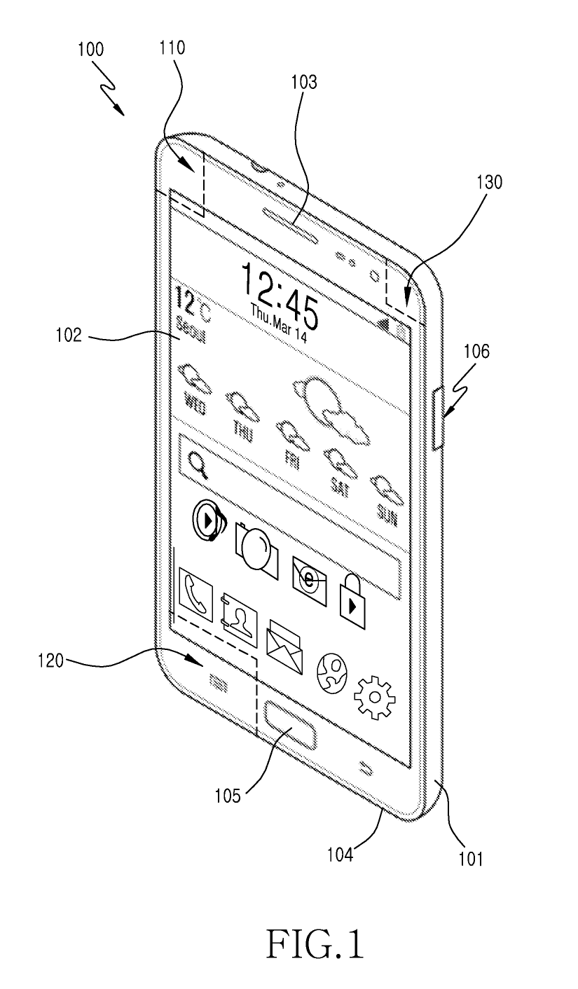

FIG. 1 illustrates an electronic device according to an embodiment of the present invention.

Referring to FIG. 1, in an electronic device 100, a frame 101 forms an external appearance of a rear surface, and at a front surface, a display module 102 is disposed. Here, the display module 102 represents a touch screen including a touch panel that can simultaneously perform data input and output and a Liquid Crystal Display (LCD) module.

In the electronic device 100, in an upper portion of the display module 102, a speaker device 103 is disposed, and in a lower portion thereof, a microphone device 104 and a home button 105 are disposed.

In the electronic device 100, at a side surface thereof, a key button 106 is disposed. For example, the key button 106 may be used as a volume key button or a power key button of the electronic device 100. According to an embodiment of the present invention, the power key button may be used as a mode conversion key button for converting an idle mode or an active mode of the electronic device 100.

On the inside of the electronic device 100, antennas for a communication service are disposed. According to an embodiment of the present invention, the antennas are disposed at the inside of areas 110, 120 and 130 indicated by a dotted line of FIG. 1. According to an embodiment of the present invention, in the areas 110, 120 and 130, a data antenna for a data communication service, an audio antenna for an audio communication service, and a diversity antenna for data communication are included. A disposition area of the antennas may be changed. According to an embodiment of the present invention, the audio antenna having a volume smaller than that of the data antenna may be disposed at an upper end portion of the electronic device 100, and the data antenna having a volume larger than that of the audio antenna may be disposed at a lower end portion of the electronic device 100. According to another embodiment of the present invention, in order to satisfy a Specific Absorption Rate (SAR), the audio antenna may be disposed at a lower end portion of the electronic device 100.

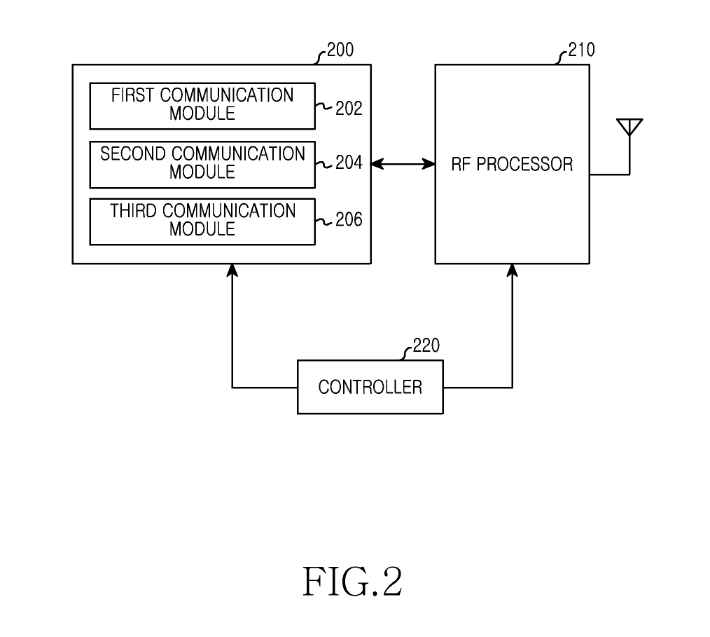

FIG. 2 is a block diagram illustrating a configuration of an electronic device according to an embodiment of the present invention.

Referring to FIG. 2, the electronic device includes a modem 200, a Radio Frequency (RF) processor 210, and a controller 220.

The modem 200 searches for a frequency band corresponding to a communication method (or a network), and the electronic device may have a modem for each communication method or may implement a one-chip modem, thereby searches for a frequency band corresponding to a plurality of communication methods.

According to an embodiment of the present invention, the modem 200 includes a first communication module 202 that searches for a frequency band of a first communication method, a second communication module 204 that searches for a frequency band of a second communication method, and a third communication module 206 that searches for a frequency band of a third communication method. The first communication method may include at least one of a Global System for Mobile Communication (GSM) network, an Enhanced Data GSM Environment (EDGE) network, and a Code Division Multiple Access (CDMA) network, the second communication method may include at least one of a Wideband-CDMA (W-CDMA) network and a Time Division Synchronous CDMA (TD-SCDMA) network, and the third communication method may include at least one of a Wireless Broadband (WiBro) network and a Long Term Evolution (LTE) network.

The modem 200 processes an audio or data signal of a baseband transmitted and received through an antenna, and the RF processor 210 processes an audio signal or a data signal transmitted and received through an antenna. According to an embodiment of the present invention, the RF processor 210 converts an RF signal received through the antenna to a baseband signal and converts a baseband signal received from the modem 200 to an RF signal.

In order to reduce power consumption, the controller 220 controls a frequency band search operation. According to an embodiment of the present invention, the controller 220 controls a frequency band search operation based on a previously defined condition. For example, the previously defined condition may be related to a state of the electronic device, such as at least one of a battery level, a location, and an available service.

According to an embodiment of the present invention, the control of the frequency band search operation may limit a search band. The controller 220 processes not to perform a search operation of at least one frequency band, except for a main frequency band of an entire frequency band which the electronic device supports.

According to another embodiment of the present invention, the control of the frequency band search operation may adjust at least one of a search order and a search cycle for a frequency band. The controller 220 preferentially searches for a main frequency band of an entire frequency band which the electronic device supports or reduces a search for the other frequency bands other than a main frequency band. According to an embodiment of the present invention, the controller 220 provides a high priority to the main frequency band and preferentially operates a modem that searches for a main frequency band. According to another embodiment of the present invention, by increasing a sleep time of a modem that searches for other frequency bands, except for a main frequency band, the controller 220 reduces a search for a frequency band other than a main frequency band.

The main frequency band may include a frequency band corresponding to a network generally used in the electronic device before satisfying a previously defined condition, for example, before it is determined that a battery level is less than a threshold value and a network that may be used at a present location by a present setting of the electronic device exists.

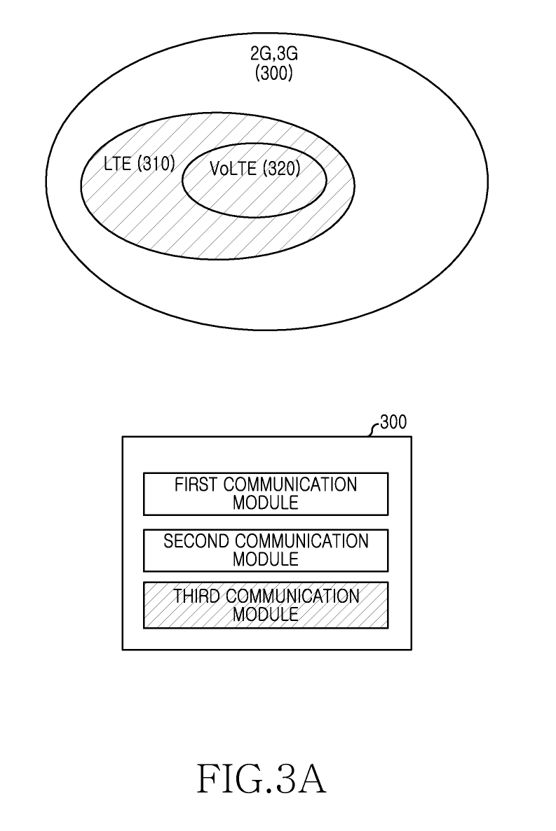

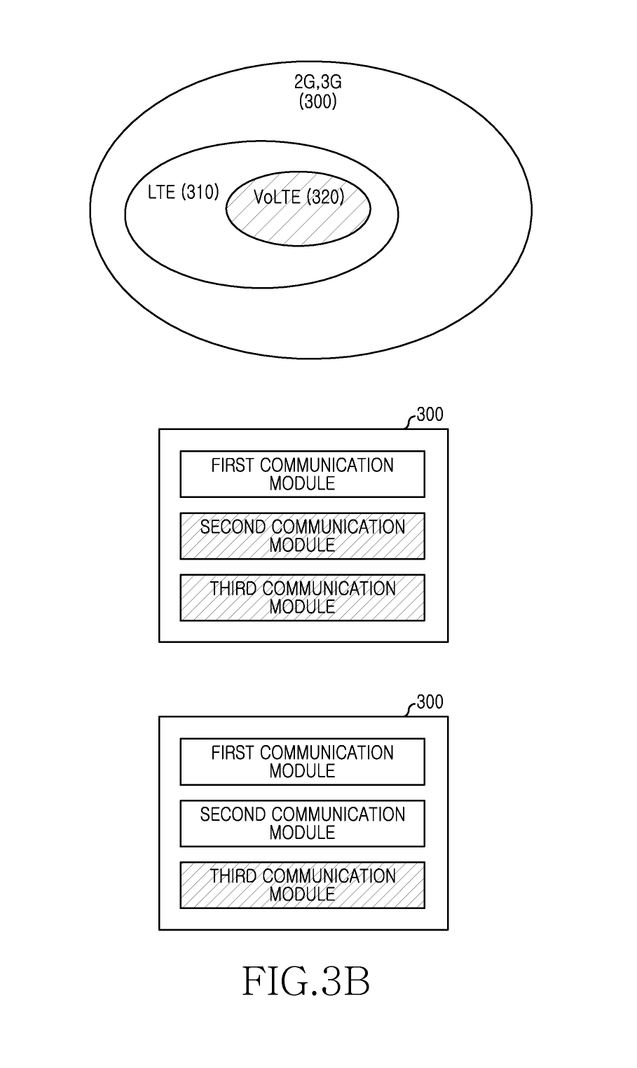

FIG. 3A is a diagram illustrating a network search operation of an electronic device according to an embodiment of the present invention.

Referring to FIG. 3A, the electronic device supports a first communication method, a second communication method, and a third communication method. According to an embodiment of the present invention, the first communication method may include at least one of a GSM network, an EDGE network, and a CDMA network, the second communication method may include at least one of a W-CDMA network and a TD-SCDMA network, and the third communication method may include at least one of a WiBro network and a Long Term Evolution (LTE) network.

According to an embodiment of the present invention, when the electronic device supports a first communication method corresponding to a 2 G communication method (800 MHz frequency band), a second communication method corresponding to a 3G communication method (2.1 GHz frequency band), and a third communication method corresponding to an LTE communication method (850 MHz frequency band), the electronic device performs a search operation for the frequency bands 800 MHz, 2.1 GHz, and 850 MHz.

According to an embodiment of the present invention, the electronic device performs a frequency band search operation based on a state of the electronic device (e.g., a battery level).

According to an embodiment of the present invention, when it is determined that a battery level is less than a threshold value, the electronic device controls the number of frequency bands to be searched for or controls a priority of a frequency band to be searched for. The control of the number of the frequency bands to be searched for may be not to perform a frequency band search operation of at least one frequency band, except for a main frequency band in the electronic device.

The control of a priority of a network to be searched for may be to change a search cycle or a search order. According to an embodiment of the present invention, the electronic device may extend a search cycle for the remaining frequency bands, except for a main frequency band. According to an embodiment of the present invention, by extending a sleep period of a modem corresponding to the remaining frequency bands, except for a main frequency band, the electronic device may extend a search cycle for the remaining frequency bands other than a main frequency band.

The main frequency band may be a frequency band corresponding to a network generally used by the electronic device. According to an embodiment of the present invention, by generating a list of the used network, the electronic device determines a frequently used frequency band (or a frequency band frequently set by a user) and defines a main frequency band. According to another embodiment of the present invention, the electronic device determines a network used before it is determined that a battery level is less than a threshold value and defines a main frequency band.

As shown in FIG. 3A, at a location that supports an LTE communication method 310 or a VoLTE communication method 320, when an electronic device that supports 2G and 3G communication methods 300, an LTE communication method 310, and a VoLTE communication method 320 determines that a battery level is less than a threshold value while using an LTE communication method 310, by activating only a third communication module corresponding to the LTE communication method 310, the electronic device enables to perform a frequency band search operation. In FIG. 3A, a communication module on which a shading is applied is in an activated state.

According to an embodiment of the present invention, in order to reduce power consumption, when entering a low power mode, the electronic device deactivates a first communication module and a second communication module, and keeps a third communication module corresponding to a main frequency band activated. When it is necessary to search for other communication methods according to a connection possibility, a user environment, and a network policy, the electronic device may perform a search operation with a cycle longer than that of a main frequency band. In such a case, the first communication module and the second communication module maintains a sleep state for a time longer than that of a third communication module corresponding to a main frequency band, and may be woke up.

FIG. 3B is a diagram illustrating a network search operation of an electronic device according to an embodiment of the present invention.

Referring to FIG. 3B, the electronic device supports a first communication method, a second communication method, and a third communication method. According to an embodiment of the present invention, the first communication method may include at least one of a GSM network, an EDGE network, and a CDMA network, the second communication method may include at least one of a W-CDMA network and a TD-SCDMA network, and the third communication method may include at least one of a WiBro network and an LTE network.

According to an embodiment of the present invention, the electronic device performs a frequency search operation based on a state of the electronic device (e.g., a battery level, a location, and an available service).

According to an embodiment of the present invention, when it is determined that a battery level is less than a threshold value, the electronic device controls the number of frequency bands to be searched for or controls a priority of a frequency band to be searched for based on whether a function (e.g., VoLTE) of performing an audio service is used through data communication.

As shown in FIG. 3B, at a location that supports a VoLTE communication method 320, when it is determined that a battery level is less than a threshold value, an electronic device that supports 2G and 3G communication methods 300, an LTE communication method 310, and the VoLTE communication method 320 determines whether a VoLTE function is activated.

When it is determined that the VoLTE function is deactivated, the electronic device activates respective communication modules (e.g., a second communication module and a third communication module) of a 4G network and a 3G network, thereby performs a frequency band search operation for a data service using the 4G network and an audio service using the 3G network.

When it is determined that the VoLTE function is activated, the electronic device activates only a communication module (e.g., a third communication module) of the 4G network, thereby performs a network search operation for a data service and an audio service. In FIG. 3B, a communication module in which a shading is applied is in an activated state.

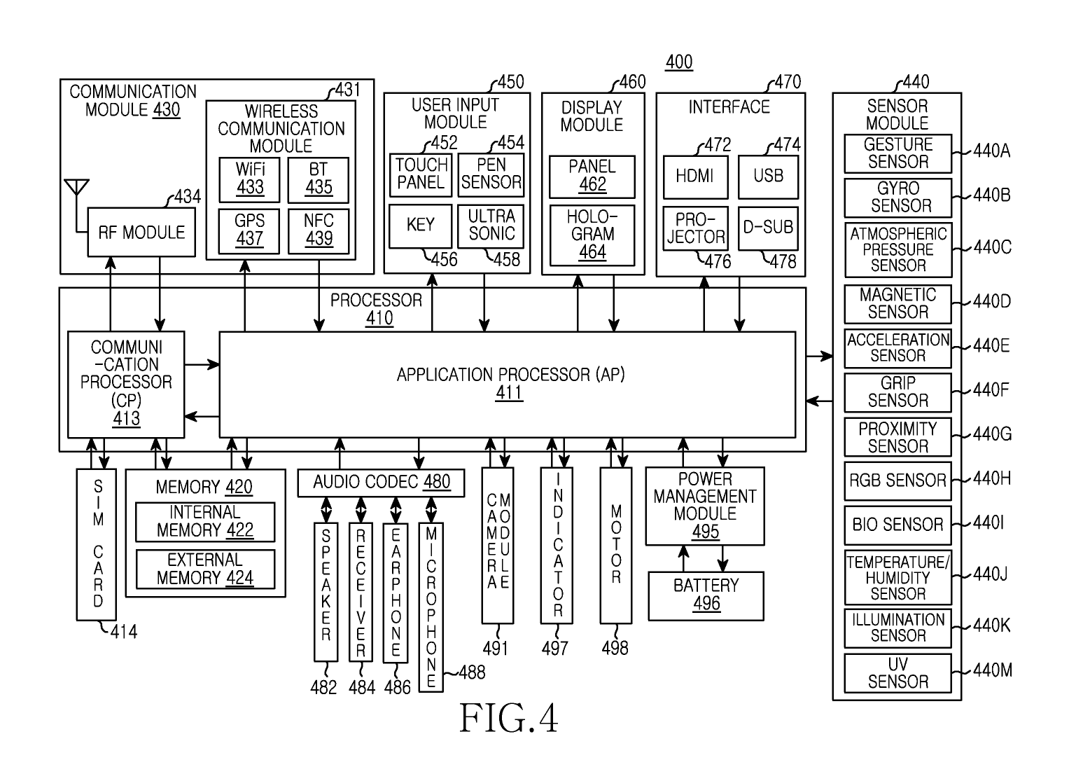

FIG. 4 is a block diagram illustrating a configuration of an electronic device 400 according to an embodiment of the present invention. The electronic device 400 may be, for example, the electronic device of FIG. 2.

Referring to FIG. 4, the electronic device 400 includes at least one processor 410, a Subscriber Identification Module (SIM) card 414, a memory 420, a communication module 430, a sensor module 440, a user input module 450, a display module 460, an interface 470, an audio codec 480, a camera module 491, a power management module 495, a battery 496, an indicator 497, or a motor 498.

The processor 410 includes at least one Application Processor (AP) 411 or at least one Communication Processor (CP) 413. The processor 410 may be, for example, the controller 220 of FIG. 2, and as described with reference to FIG. 2, in order to reduce power consumption, the processor 410 controls a frequency band search operation. According to an embodiment of the present invention, the processor 410 controls a frequency band search operation based on a state (e.g., a battery level, a location, and an available service) of the electronic device 400. According to an embodiment of the present invention, the processor 410 may not perform a search operation for at least one frequency band, except for a main frequency band of an entire frequency band which the electronic device supports. According to another embodiment of the present invention, the processor 410 preferentially searches for a main frequency band of an entire frequency band which the electronic device supports or reduces a search for the other frequency bands other than a main frequency band. The main frequency band may include a frequency band corresponding to a network generally used in the electronic device before it is determined that a battery level is less than a threshold value and a network that may be used at a present location by a present setting of the electronic device exists.

The AP 411 drives an operation system or an application program to control a plurality of hardware or software components connected to the AP 411 and performs various data processing and operations including multimedia data. The AP 411 may be implemented with, for example, a System on Chip (SoC). According to an embodiment of the present invention, the processor 410 may further include a Graphic Processing Unit (GPU).

The CP 413 performs a function of managing a data link or converting a communication protocol in communication between an electronic device (e.g., the electronic device 100) including the electronic device 400 and electronic devices connected by a network. The CP 413 may be implemented with, for example, an SoC. According to an embodiment of the present invention, the CP 413 performs at least a portion of a multimedia control function. The CP 413 performs identification and authentication of a terminal within a communication network using, for example, an SIM (e.g., the SIM card 414). Further, the CP 413 provides services such as audio dedicated communication, audiovisual communication, a text message, or packet data to the user.

The CP 413 controls data transmission and reception of the communication module 430. In FIG. 4, elements such as the CP 413, the power management module 495, or the memory 420 are elements separate from the AP 411, but according to an embodiment of the present invention, the AP 411 may include at least a portion (e.g., the CP 413) of the foregoing elements.

According to an embodiment of the present invention, the AP 411 or the CP 413 loads and processes an instruction or data received from at least one of other elements in a volatile memory, or in a non-volatile memory connected to each of the AP 411 and the CP 413. Further, the AP 411 or the CP 413 stores data received from at least one of other elements or generated by at least one of other elements at a non-volatile memory.

The SIM card 414 is a card that implements an SIM and may be inserted into a slot formed at a specific location of the electronic device 400. The SIM card 414 may include intrinsic identification information (e.g., Integrated Circuit Card Identifier (ICCID)) or subscriber information (e.g., International Mobile Subscriber Identity (IMSI)).

The memory 420 includes an internal memory 422 or an external memory 424. The internal memory 422 may include at least one of, for example, a volatile memory (e.g., a Dynamic RAM (DRAM), a Static RAM (SRAM), a Synchronous Dynamic RAM (SDRAM)), or a non-volatile memory (e.g., a One Time Programmable ROM (OTPROM), a Programmable ROM (PROM), an Erasable and Programmable ROM (EPROM), an Electrically Erasable and Programmable ROM (EEPROM), a mask ROM, a flash ROM, a NAND flash memory, and a NOR flash memory). According to an embodiment of the present invention, the internal memory 422 may have a form of a Solid State Drive (SSD). The external memory 424 may further include a flash drive, for example, a Compact Flash (CF), Secure Digital (SD), Micro Secure Digital (Micro-SD), Mini Secure Digital (Mini-SD), extreme Digital (xD), or a memory stick.

The communication module 430 includes a wireless communication module 431 or a Radio Frequency (RF) module 434. The communication module 430 may be, for example, the modem 200 of FIG. 2. The wireless communication module 431 includes, for example, a WiFi module 433, a Bluetooth (BT) module 435, a GPS module 437, or a Near Filed Communication (NFC) module 439. For example, the wireless communication module 431 provides a wireless communication function using a radio frequency. Alternatively, the wireless communication module 431 may include a modem or a network interface (e.g., a Local Area Network (LAN) card) that connects the electronic device 400 to a network (e.g., Internet, a LAN, a Wide Area Network (WAN), a telecommunication network, a cellular network, a satellite network, or a Plain Old Telephone Service (POTS)).

The RF module 434 performs transmission and reception of data, for example, transmission and reception of an RF signal or a called electronic signal. Although not shown, the RF module 434 may include, for example, a transceiver, a Power Amp Module (PAM), a frequency filter, or a Low Noise Amplifier (LNA). The RF module 434 may further include a component, for example, a conductor or a conductive wire that transmits and receives electromagnetic waves on a free space in wireless communication.

The sensor module 440 includes at least one of, for example, a gesture sensor 440A, a gyro sensor 440B, an atmospheric pressure sensor 440C, a magnetic sensor 440D, an acceleration sensor 440E, a grip sensor 440F, a proximity sensor 440G, a Red, Green, and Blue (RGB) sensor 440H, a bio sensor 440I, a temperature/humidity sensor 440J, an illumination sensor 440K, or a Ultra Violet (UV) sensor 440M. The sensor module 440 measures a physical amount or detects an operation state of an electronic device and converts measured or detected information to an electronic signal. Alternatively, the sensor module 440 may include, for example, an E-nose sensor, an electromyography sensor (EMG sensor), an electroencephalogram sensor (EEG sensor), an electrocardiogram sensor (ECG sensor), or a fingerprint sensor. The sensor module 440 may further include a control circuit that controls at least one sensor belonging to the inside thereof.

The user input module 450 includes a touch panel 452, a (digital) pen sensor 454, a key 456, or an ultrasonic wave input device 458.

The touch panel 452 recognizes a touch input with at least one method of, for example, a capacitive, resistive, infrared ray, or ultrasonic wave method. The touch panel 452 may further include a controller. A capacitive touch panel performs proximity recognition as well as a direct touch. The touch panel 452 may further include a tactile layer. In this case, the touch panel 452 provides a haptic reaction to the user.

The (digital) pen sensor 454 may be implemented using a method same as or similar to that of, for example, reception of a touch input of the user or a separate recognition sheet.

For example, a keypad or a touch key may be used as the key 456.

The ultrasonic wave input device 458 determines data by detecting a sound wave with a microphone (e.g., the microphone 488) in a terminal through a pen that generates an ultrasonic wave signal and performs wireless recognition.

According to an embodiment of the present invention, the electronic device 400 receives a user input from an external device (e.g., a network, a computer, or a server) connected to the communication module 430 using the communication module 430.

The display module 460 includes a panel 462 or a hologram device 464. The panel 462 may be, for example, a Liquid Crystal Display (LCD) or an Active-Matrix Organic Light-Emitting Diode (AMOLED). The panel 462 may be implemented with, for example, a flexible, transparent, or wearable method. The panel 462 and the touch panel 452 may be formed in a module. The hologram device 464 shows a stereoscopic image in the air using interference of light. According to an embodiment of the present invention, the display module 460 may further include a control circuit for controlling the panel 462 or the hologram device 464.

The interface 470 includes, for example, a High-Definition Multimedia Interface (HDMI) 472, a Universal Serial Bus (USB) 474, a projector 476, or a D-subminiature (D-sub) 478. Alternatively, the interface 470 may include, for example, Secure Digital (SD)/Multi-Media Card (MMC)(not shown), or Infrared Data Association (IrDA) (not shown).

The audio codec 480 interactively converts an audio signal and an electric signal. For example, the audio codec 480 converts audio information input or output through, for example, a speaker 482, a receiver 484, an earphone 486, or a microphone 488 into an electric signal, and converts an electric signal into an audio signal.

The camera module 491 photographs an image and a moving picture, and according to an embodiment of the present invention, the camera module 491 may include at least one image sensor (e.g., a front surface lens or a rear surface lens), an Image Signal Processor (ISP), or a flash LED.

The power management module 495 manages power of the electronic device 400. Although not shown, the power management module 495 may include, for example, a Power Management Integrated Circuit (PMIC), a charger Integrated Circuit (charger IC), or a battery fuel gauge.

The PMIC may be mounted within, for example, an IC or an SoC semiconductor. A charging method may be classified into a wired method and a wireless method.

The charger IC charges a battery and prevents an overvoltage or an overcurrent from being injected from a charger. According to an embodiment of the present invention, the charger IC may include a charger IC for at least one of a wired charging method and a wireless charging method. The wireless charging method may include, for example, a magnetic resonance method, a magnetic induction method, or an electromagnetic wave method and may add an additional circuit, for example, a circuit such as a coil loop, a resonant circuit, and a rectifier for wireless charging.

The battery gauge measures, for example, a residual quantity of the battery 496, a voltage, a current, or a temperature while charging.

The battery 496 generates electricity to supply power and may be, for example, a rechargeable battery.

The indicator 497 displays a specific state, for example, a booting state, a message state, or a charge state of the electronic device 400 or a portion (e.g., the AP 411) thereof.

The motor 498 converts an electrical signal to a mechanical vibration.

Although not shown, the electronic device 400 may include a processing device (e.g., GPU) for supporting a mobile TV. The processing device for supporting a mobile TV processes media data according to a specification such as Digital Multimedia Broadcasting (DMB), Digital Video Broadcasting (DVB), or media flow.

According to an embodiment of the present invention, the electronic device may include a first modem that searches for a frequency band corresponding to a first communication method; a second modem that searches for a frequency band corresponding to a second communication method; and a controller that determines situation information of the electronic device, that searches for a frequency band using the first modem and the second modem, when it is determined that the situation information does not satisfy a condition, and that searches for a frequency band using the first modem or the second modem, when it is determined that the situation information satisfies the condition.

According to an embodiment of the present invention, the controller may operate the first modem or the second modem that searches for a frequency band having a high priority, when it is determined that the situation information satisfies the condition.

According to an embodiment of the present invention, the situation information of the electronic device may include at least one of a battery level and location information of the electronic device.

According to an embodiment of the present invention, the controller may operate the first modem or the second modem for searching for a frequency band used when it is determined that the battery level does not satisfy the condition, when it is determined that the battery level satisfies the condition.

According to an embodiment of the present invention, the controller may operate the first modem or the second modem for searching for a frequency band corresponding to a network that can be used at a present location, when it is determined that the present location satisfies the condition.

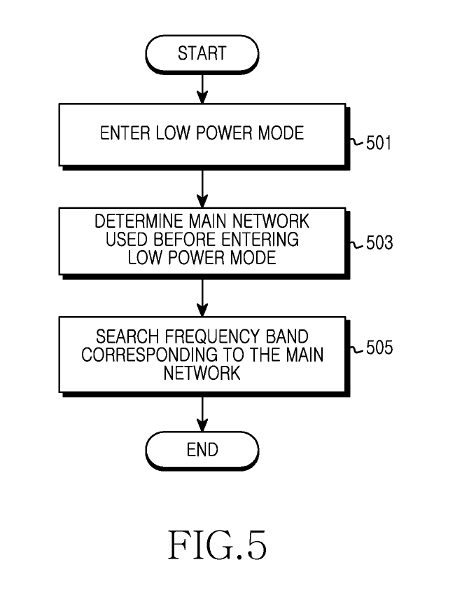

FIG. 5 is a flowchart illustrating a network search operation of an electronic device according to an embodiment of the present invention.

At step 501, the electronic device enters a low power mode in order to reduce power consumption. According to an embodiment of the present invention, when it is determined that a battery level is less than a threshold, the electronic device enters a low power mode. According to another embodiment of the present invention, when an input is not detected for a predetermined time, the electronic device enters a low power mode.

At step 503, the electronic device determines a main network (or a communication method) used before entering a low power mode. According to an embodiment of the present invention, the electronic device manages information about the used network. According to an embodiment of the present invention, the main network is a network generally used by the electronic device and a network used before entering a low power mode.

At step 505, the electronic device performs a frequency band search operation corresponding to the main network.

According to an embodiment of the present invention, the electronic device supports a plurality of networks. According to an embodiment of the present invention, the electronic device supports at least two networks of a 2G network, a 3G network, and a 4G network.

When the electronic device determines a 4G network as a main network at a time point that enters a low power mode, the electronic device performs a frequency band search operation corresponding to the 4G network. In the frequency search operation corresponding to the 4G network, when the electronic device supports a frequency band (band 1) corresponding to a 3G network (2.1 GHz) and a frequency band (band 5) corresponding to an LTE network (850 MHz), the electronic device performs an operation of searching for only a frequency band corresponding to the LTE network (850 MHz) instead of an operation of supporting a frequency band search operation corresponding to the 3G network (2.1 GHz).

According to an embodiment of the present invention, the electronic device activates only a search operation for a frequency band corresponding to the LTE network (850 MHz) and deactivates a search operation for a frequency band corresponding to the 3G network (2.1 GHz).

According to another embodiment of the present invention, when a frequency band search operation corresponding to the LTE network (850 MHz) and a frequency band search operation corresponding to the 3G network (2.1 GHz) are activated, the electronic device adjusts a cycle of a frequency band search operation corresponding to the 3G network (2.1 GHz). The electronic device processes to extend a sleep cycle of a communication module that searches for a frequency band corresponding to the 3G network (2.1 GHz).

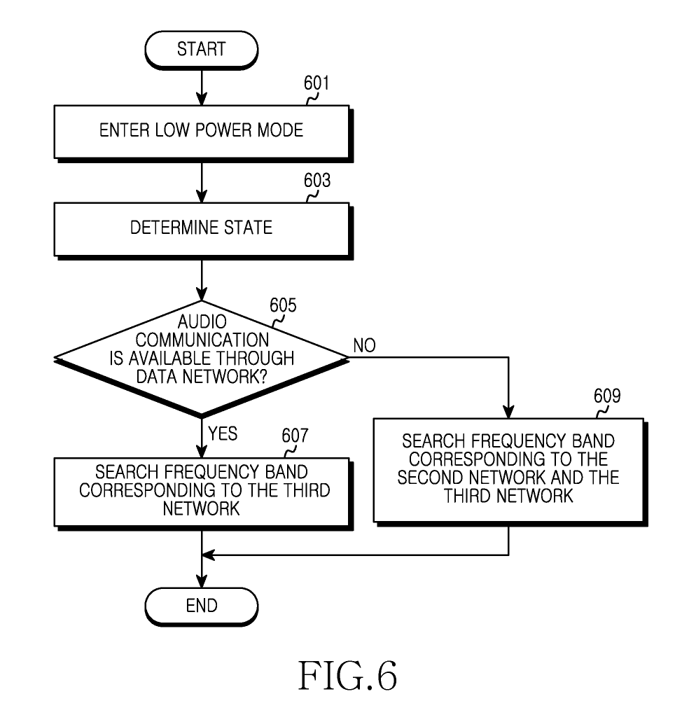

FIG. 6 is a flowchart illustrating a network search operation of an electronic device according to another embodiment of the present invention.

At step 601, the electronic device enters a low power mode in order to reduce power consumption. According to an embodiment of the present invention, when it is determined that a battery level is less than a threshold, the electronic device enters a low power mode. According to another embodiment of the present invention, when an input is not detected for a predetermined time period, the electronic device enters a low power mode.

At step 603, the electronic device determines a state thereof. Here, a state of the electronic device may include a location and an available service of the electronic device. According to an embodiment of the present invention, the available service may include a VoLTE function.

At step 605, the electronic device determines whether audio communication is available through data communication. According to an embodiment of the present invention, the electronic device determines whether a VoLTE function is activated at a location where a VoLTE function can be performed.

If it is determined that audio communication is available through data communication (e.g., it is determined that a VoLTE function is activated), at step 607, the electronic device performs a frequency band search operation corresponding to a third network. Here, the third network may include a 4G network for data communication.

If it is determined that audio communication is not available through data communication (e.g., it is determined that a VoLTE function is deactivated), at step 609, the electronic device performs a network search operation corresponding to a second network and the third network. Here, the second network may include a 3G network for audio communication.

According to an embodiment of the present invention, the electronic device supports a plurality of bands of each network. According to an embodiment of the present invention, the electronic device supports a frequency band of 850 MHz, 900 MHz, 1700 MHz, 1900 MHz, and 2100 MHz for a 3G network and supports a frequency band of 850 MHz for a 4G network.

When the electronic device determines that a VoLTE function is activated in a region that can use an LTE service, the electronic device may perform only a search operation for an LTE 850 MHz frequency band.

When the electronic device determines that a VoLTE function is deactivated in a region that can use an LTE service, the electronic device may perform a search operation for an LTE 850 MHz frequency band and an operation of selecting and searching for only one frequency band of various frequency bands of a 3G network. The electronic device may adjust a search cycle for the remaining frequency bands of a 3G network.

Because the electronic device can provide sound and data services using a 4G network through a VoLTE function, the electronic device prevents an unnecessary search operation for a 3G or 2G network from being performed, thereby reduces power consumption.

According to an embodiment of the present invention, a method of searching for a network performed by an electronic device may include operations of determining a battery level of the electronic device, searching for a first frequency band, when it is determined that the battery level is greater than or equal to a threshold value, and searching for a second frequency band when it is determined that the battery level is less than a threshold value. For example, the first frequency band may include an entire frequency band corresponding to a network which the electronic device supports, and the second frequency band may include a frequency band except for at least one frequency band included in the first frequency band.

According to an embodiment of the present invention, the second frequency band may include at least one of a frequency band corresponding to a network used in the electronic device before it is determined that the battery level is less than the threshold value and a frequency band corresponding to a network that can be used at a location of the electronic device.

According to an embodiment of the present invention, the operation of searching for the second frequency band may include an operation of adjusting a search cycle for at least one frequency band included in the second frequency band.

According to an embodiment of the present invention, the operation of searching for the second frequency band may include an operation of deactivating a search for at least one frequency band included in the second frequency band.

According to an embodiment of the present invention, the operation of searching for the second frequency band may include an operation of setting a priority of at least one frequency band included in the second frequency band to be searched.

Various embodiments of the present invention may be implemented in a form of hardware, software, or a combination of hardware and software.

When implemented with software, a computer readable storage medium that stores at least one program (software module) may be provided. At least one program stored at a computer readable storage medium may be configured for execution by at least one processor within an electronic device. At least one program may include instructions that enable an electronic device to execute methods according to embodiments described in a specification or claims of the present invention.

According to an embodiment of the present invention, the instruction may execute an operation of searching for a full frequency band using a first modem and a second modem and an operation of controlling the first modem or the second modem based on a battery level of an electronic device.

According to an embodiment of the present invention, when it is determined that the battery level is less than a threshold value, the instruction may execute an operation of controlling the number of search frequency bands or a priority of search frequency bands.

According to an embodiment of the present invention, the instruction may execute an operation of determining whether a VoLTE function is set, an operation of activating a second modem when it is determined that the a VoLTE function is set, and an operation of activating a first modem and a second modem when it is determined that the VoLTE function is not set.

According to an embodiment of the present invention, the instruction may execute an operation of searching for a frequency band corresponding to a 3G communication method with a first modem, and an operation of searching for a frequency band corresponding to an LTE communication method with a second modem.

Such a program (software module, software) may be stored at a non-volatile memory including a Random Access Memory (RAM) and a flash memory, a Read-Only Memory (ROM), an Electrically Erasable and Programmable ROM (EEPROM), a magnetic disk storage device, a Compact Disk ROM (CD-ROM), a Digital Versatile Disk (DVD), or an optical storage device of other form, and a magnetic cassette. Alternatively, the program may be stored at a memory formed with a combination of a portion or the entire thereof. Further, each constituent memory may be included in plural.

The program may be stored at an attachable storage device that may access through a communication network such as Internet, Intranet, a LAN, a Wireless LAN (WLAN), a Storage Area Network (SAN), or a communication network formed with a combination thereof. Such a storage device may access to the electronic device through an external port.

A separate storage device in the communication network may access to a portable electronic device.

An electronic device according to an embodiment of the present invention controls a network search operation according to, for example, a previously defined condition, thereby reducing power consumption.

In a detailed description of the present disclosure, embodiments have been described, but an operation order of an electronic device may be changed, combined, or reused without deviating from the scope of the present invention and may be changed to several forms. Therefore, the scope of the present invention is not limited to the described embodiment but should be determined by the appended claims and their equivalents.

What is claimed is:

1. A method of searching for a network performed by an electronic device, the method comprising:
determining a battery level of the electronic device;
searching for a first frequency band, when it is determined that the battery level is greater than or equal to a threshold value; and
searching for a second frequency band, when it is determined that the battery level is less than the threshold value,
wherein the first frequency band comprises an entire frequency band corresponding to a network which the electronic device supports, and
wherein the second frequency band comprises a frequency band other than at least one frequency band included in the first frequency band.

2. The method of claim 1, wherein the second frequency band comprises at least one of a frequency band corresponding to a network used in the electronic device before it is determined that a battery level is less than the threshold value and a frequency band corresponding to a network that can be used at a location of the electronic device.

3. The method of claim 1, wherein searching for the second frequency band comprises adjusting a search cycle for at least one frequency band included in the second frequency band.

4. The method of claim 1, wherein searching for the second frequency band comprises deactivating a search for at least one frequency band included in the second frequency band.

5. The method of claim 1, wherein searching for the second frequency band comprises setting a priority of at least one frequency band included in the second frequency band to be searched.

6. An electronic device for searching for a network, the electronic device comprising:
a first modem configured to search for a frequency band corresponding to a first communication method;
a second modem configured to search for a frequency band corresponding to a second communication method; and
a controller configured to determine situation information of the electronic device, to search for a frequency band using the first modem and the second modem, when it is determined that the situation information does not satisfy a condition, and to search for a frequency band using the first modem or the second modem, when it is determined that the situation information satisfies the condition.

7. The electronic device of claim 6, wherein the controller is further configured to operate the first modem or the second modem that searches for a frequency band having a high priority, when it is determined that the situation information satisfies the condition.

8. The electronic device of claim 6, wherein the situation information of the electronic device comprises at least one of a battery level and location information of the electronic device.

9. The electronic device of claim 8, wherein the controller is further configured to operate the first modem or the second modem for searching for a frequency band used when the battery level does not satisfy the condition, when it is determined that the battery level satisfies the condition.

10. The electronic device of claim 8, wherein the controller is further configured to operate the first modem or the second modem for searching for a frequency band corresponding to a network that can be used at a present location, when it is determined that the present location satisfies the condition.

11. A non-transitory computer readable recording medium having recorded thereon a program for executing an operation of searching for a full frequency band using a first modem and a second modem and an operation of controlling the first modem or the second modem based on a battery level of an electronic device in the electronic device.

12. The non-transitory computer readable recording medium of claim 11, wherein the program for executing the operation of controlling the first modem or the second modem comprises a program for executing an operation of controlling a number of search frequency bands or a priority of search frequency bands, when it is determined that the battery level is less than a threshold value.

13. The non-transitory computer readable recording medium of claim 11, wherein the program for executing the operation of controlling the first modem or the second modem comprises a program for executing an operation of determining whether a Voice over Long Term Evolution (VoLTE) function is set and an operation of activating the second modem when it is determined that the VoLTE function is set and activating the first modem and the second modem when it is determined that the VoLTE function is not set.

14. The non-transitory computer readable recording medium of claim 13, wherein the first modem comprises a program that enables to search for a frequency band corresponding to a 3G communication method, and
wherein the second modem comprises a program that enables to search for a frequency band corresponding to an LTE communication method.
